(19) United States
(12) Patent Application Publication
(10) Pub. No.: US 2018/0157070 A1
(43) Pub. Date: Jun. 7, 2018

(54) LIQUID CRYSTAL DISPLAY PANEL

(71) Applicant: Shenzhen China Star Optoelectronics Technology Co. Ltd., Shenzhen, Guangdong (CN)

(72) Inventor: Chuan WU, Shenzhen (CN)

(73) Assignee: Shenzhen China Star Optoelectronics Technology Co. Ltd., Shenzhen, Guangdong (CN)

(21) Appl. No.: 14/897,491

(22) PCT Filed: Sep. 6, 2015
(86) PCT No.: PCT/CN2015/088956

§ 371 Date: Jan. 29, 2018

(30) Foreign Application Priority Data
Aug. 27, 2015 (CN) 201510534485.7

(51) Int. Cl. G02F 1/1339; G02F 1/1335

(52) U.S. Cl. CPC G02F 1/1339; G02F 1/133514; G02F 1/1362; G02F 2001/13398; G02F 1/13394

(57) ABSTRACT

In order to eliminate the defect in the prior art of incomplete curing of part of the sealant, the present disclosure provides a liquid crystal display panel. The liquid crystal display comprises an array substrate, a color filter substrate, and a sealant disposed between the array substrate and the color filter substrate. A position of at least part of the sealant corresponds to a gap in a patterned metal layer of the array substrate. As a result, the sealant can be sufficiently radiated and completed cured.

### CROSS REFERENCE TO RELATED APPLICATION

The present application claims the priority of Chinese patent application CN 201510534485.7, entitled “Liquid Crystal Display Panel” and filed on Aug. 27, 2015, the entirety of which is incorporated herein by reference.

### TECHNICAL FIELD

The present disclosure relates to the technical field of liquid crystal display, and in particular, to a liquid crystal display panel.

### TECHNICAL BACKGROUND

In the manufacturing process of a thin film transistor liquid crystal display (TFT-LCD), color filter is sometimes used to replace photo spacers (PS) as the upholder at the sealant, so as to achieve the design of narrow frame. Part of an active area (AA) has a small distance from the sealant and the photo spacer used in the sealant has a smaller support force than that used in the central area in the AA. As a result, a cell gap adjacent to the sealant area on the edges would be smaller than that in the central area, resulting in gap mura in the part of the active area adjacent to the sealant.

Under normal circumstances, in order to realize a design of narrow frame, the sum total of the width d1 of the color filter and the width d2 of the sealant should be kept within a certain range. However, if the width d1 of the color filter is too large, the width d2 of the sealant would be too small, such that the adhesion of the sealant will be insufficient, whereby an upper substrate and a lower substrate would be separated with only slight external force. If the width d1 of the color filter is too small, the width d2 of the sealant would be too large, whereby gap mura would occur due to lack of support force between the upper and the lower substrates. Therefore, the width d1 of the color filter and the width d2 of the sealant should be limited strictly. Under these circumstances, incomplete curing would occur to the sealant of the liquid crystal display panel.

### SUMMARY OF THE INVENTION

Research conducted by the inventor shows that the technical problem as mentioned in the above technical background section is because a part of ultraviolet light, which irradiates from the side of an array substrate during curing of a sealant, is blocked by a metal layer of the array substrate, causing incomplete curing of the sealant at a corresponding part.

In order to eliminate or at least relieve the above defect in the prior art, i.e., incomplete curing of part of the sealant, the present disclosure provides a liquid crystal display panel.

The liquid crystal display panel according to the present disclosure comprises an array substrate, a color filter substrate, and a sealant disposed between the array substrate and the color filter substrate, wherein a position of at least part of the sealant corresponds to a gap in a patterned metal layer of the array substrate.

In the process of curing the sealant, ultraviolet light will irradiate the liquid crystal display panel (which is a semi-finished product) from the side of the array substrate. The ultraviolet light cannot penetrate metal in the patterned metal layer when passing through the array substrate, but it can penetrate the gap in the patterned metal layer and continue projecting. In this case, the sealant at a position corresponding to the gap can receive sufficient ultraviolet radiation, thereby being cured completely. The sealant according to the present disclosure can be sufficiently irradiated and completely cured, which the prior art cannot achieve.

Preferably, the liquid crystal display panel further comprises spacer disposed between the array substrate and the color filter substrate, wherein a position of at least part of the spacer corresponds to the metal in the patterned metal layer of the array substrate.

In the process of curing the sealant, the spacer at the position corresponding to the metal will not receive radiation of ultraviolet light. Since the spacers do not need to be irradiated by ultraviolet light, there would be no negative influence on the process technology of the entire liquid crystal display panel. And with such arrangement, widths of the sealant and the spacer can satisfy strict requirement.

Preferably, the sealant corresponds to the gap, and the spacer corresponds to the metal. Under such circumstances, the total width of the sealant and the spacer can satisfy strict requirement, which not only guarantees sufficient support force, but also increases an area of the cured frame. As a result, an adhesive force of the sealant can be effectively increased, and the requirement of the widths of the sealant and the spacer can be satisfied in order to realize the design of narrow frame.

Preferably, the spacer is composed of color filter on the color filter substrate.

Preferably, the spacer is composed of at least two stacked layers of color filter. Preferably, the spacer is composed of stacked red color filter layer and blue color filter layer, and/or stacked red color filter layer and green color filter layer, and/or stacked blue color filter layer and green color filter layer.

The above solution has many advantages. For some liquid crystal display panels, a single layer color filter might not be high enough to support a specified cell gap. In this case, double layer color filter (which can be a combination of two selected from red, green, and blue color filter on the color filter substrate) can be used. Of course, the use of color filter is not definitive. Based on different manufacturing process of the liquid crystal display panel, the spacer can be composed of a single layer color filter, or of a triple layer color filter, or even of multiple layer color filter.

Preferably, cross sections of both the sealant and the spacer are trapezoid; the sealant and the spacer are staggered with respect to each other, and the sealant is fit to an adjacent spacer in a gapless manner. Because sides of trapezoids can be fit to each other, the sealant and the spacer are interlocked and engaged with each other, whereby a reliability of connection between the substrates can be improved, and deformation and mismatch between an upper substrate and a lower substrate due to external force can be relieved or avoided.

Preferably, in a process of curing the sealant with ultraviolet light, the sealant is completely exposed to the ultraviolet light passing through the array substrate by the gap in the patterned metal layer. In this case, energy of the ultraviolet light can be used to the largest extent, and the adhesive force of the sealant can reach a maximum level.

Preferably, the color filter as the spacer and filtering color filter on the color filter substrate are formed in a same procedure. Manufacturing the filtering color filter and the spacer in the same procedure has the advantages of high effectiveness and convenience, as well as low cost.

Preferably, the color filter and the sealant each comprise photoresist so as to form a layout manner consistent with the patterned metal layer. Such embodiment is very convenient and does not need extra illumination to complete the liquid crystal display panel according to the present disclosure.

In the liquid crystal display panel according to the present disclosure, the color filter and the sealant are segmented and arranged based on characteristics of curing of the sealant, so that the shape of the color filter, which acts as the spacer, can be consistent with the shape of the metal in the patterned metal layer, and the sealant is filled in the gap in the patterned metal layer. In this case, the color filter, which acts as the spacer, is composed covering the metal in the patterned metal layer. The color filter itself does not need to be irradiated by ultraviolet light. On the other hand, the sealant in the gap of the patterned metal layer can be irradiated by ultraviolet light, thereby increasing an area of the sealant that is cured by ultraviolet light. In this manner, the curing of the sealant of the liquid crystal display panel with an especially narrow frame can be facilitated, the adhesive force between the upper and the lower substrates of the liquid crystal display panel can be increased and the support force therebetween can be guaranteed through the spacers.

As long as the objective of the present disclosure is met, the above technical features can be combined in any suitable manner or substituted with equivalent technical features.

### BRIEF DESCRIPTION OF THE ACCOMPANYING DRAWINGS

The present disclosure will be described in detail based on the examples in view of the accompanying drawings. In the drawings:

FIG. 1 shows a liquid crystal display panel according to an example of the present disclosure,

FIG. 2 shows the section view along the line C-C of the liquid crystal display panel shown in FIG. 1,

FIG. 3 shows a vertical section view of the liquid crystal display panel shown in FIG. 1 in a rectangle frame (i.e., observed from the side of the array substrate),

FIG. 4 schematically shows a transmission of ultraviolet light through the liquid crystal display panel shown in FIG. 1,

FIG. 5 shows a broken-out section view of a liquid crystal display panel according to another example of the present disclosure,

FIG. 6 shows a liquid crystal display panel according to a comparison example,

FIG. 7 shows a section view along the line D-D of the liquid crystal display panel shown in FIG. 6,

FIG. 8 shows a vertical section view of the liquid crystal display panel shown in FIG. 6 in a rectangle frame (i.e., observed from the side of the array substrate), and

FIG. 9 schematically shows a transmission of ultraviolet light through the liquid crystal display panel shown in FIG. 6.

In the drawings, same components are indicated with the same reference sign. The drawings are not drawn to actual scale.

### DETAILED DESCRIPTION OF THE EMBODIMENTS

The present disclosure will be described in detail in view of the accompanying drawings.

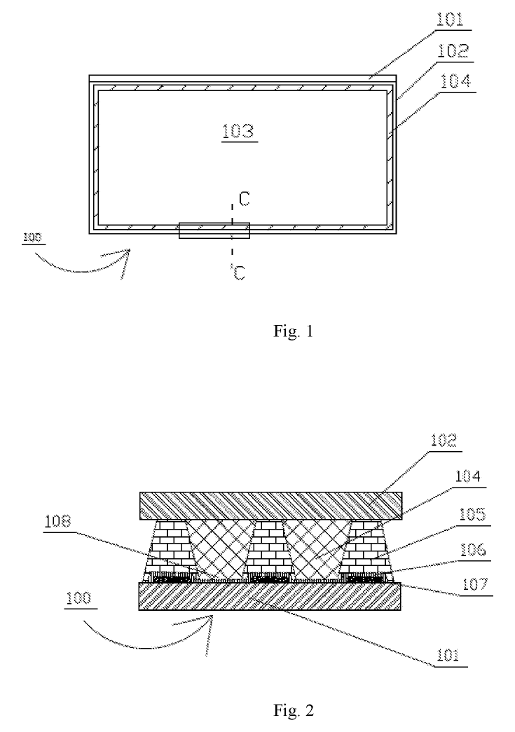

FIG. 1 shows a liquid crystal display panel 100 according to an embodiment of the present disclosure.

As shown in FIG. 1, the liquid crystal display panel 100 comprises an array substrate 101, a color filter substrate 102, and a sealant 104 disposed between the array substrate 101 and the color filter substrate 102. A patterned metal layer is disposed on the side of the array substrate 101 that is facing the color filter substrate 102. The patterned metal layer comprises metal 107 and a gap 108 (shown FIG. 2) between the metal 107. An insulating layer 106 (shown in FIG. 2) is disposed covering the metal layer.

In an active area 103 of the liquid crystal display panel 100, a liquid crystal interlayer is disposed between the array substrate 101 and the color filter substrate 102. As clearly shown in FIG. 1, the sealant 104 is composed at edges around the liquid crystal display panel 100 for encapsulating the liquid crystal interlayer.

FIG. 2 shows a section view along a line C-C of the liquid crystal display panel 100 shown in FIG. 1. As clearly shown in FIG. 2, a position of the sealant 104 corresponds to the gap 108 in the patterned metal layer of the array substrate 101. In another aspect, the liquid crystal display panel 100 further comprises spacer 105 disposed between the array substrate 101 and the color filter substrate 102. A position of the spacer 105 corresponds to the metal 107 in the patterned metal layer of the array substrate 101.

The spacer 105 can be composed of color filter on the color filter substrate 102. The color filter as the spacer 105 can be formed in a same procedure as a filtering color filter on the color filter substrate 102. In this case, in the same procedure, both the filtering color filter and the spacer 105 are prepared, which not only is efficient and convenient, but also costs low. In another aspect, the color filter 105 and the sealant 104 each can comprise photoresist (negative photoresist), so that they have a layout manner consistent with the patterned metal layer (comprising the metal 107 and the gap 108) of the array substrate 101.

In an embodiment as shown in FIG. 2, the entire sealant 104 corresponds to the gap 108 in the patterned metal layer of the array substrate 101, and the position of the spacer 105 corresponds to the metal 107 in the patterned metal layer of the array substrate 101.

As clearly shown in FIG. 2, cross sections of both the sealant 104 and the spacer 105 are trapezoid; the sealant 104 and the spacer 105 are staggered with respect to each other, and the sealant 104 is fit to the adjacent spacer 105 in a gapless manner. Because sides of trapezoids can be fit to each other, the sealant 104 and the spacer 105 are interlocked and engaged with each other, whereby a reliability of connection between the substrates can be improved, and deformation and mismatch between upper and lower substrates due to external force can be relieved or avoided.

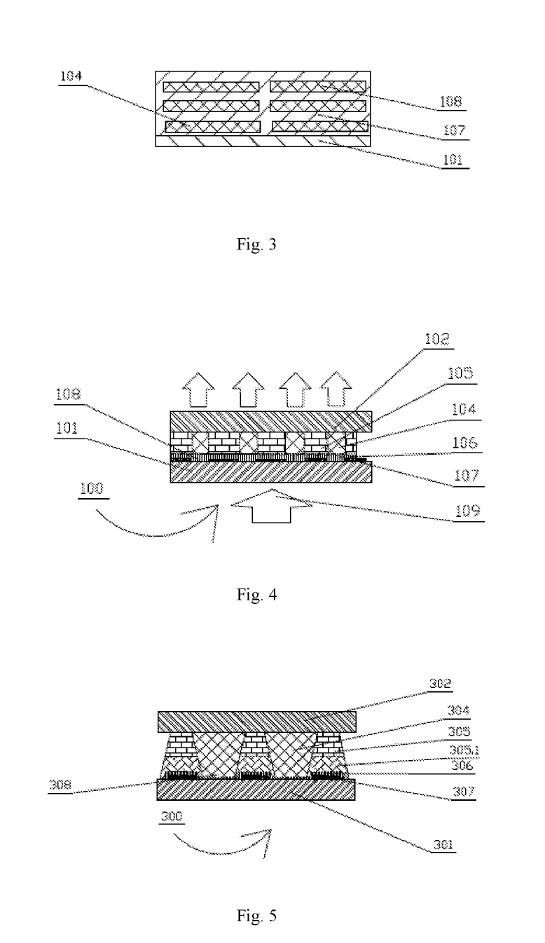

FIG. 3 shows a vertical section view of the liquid crystal display panel 100 shown in FIG. 1 in a rectangle frame (i.e., observed from the side the an array substrate). In view of FIG. 3, it should be easy to understand that if the liquid crystal display panel 100 is observed from the side of the array substrate 101, the spacer 105 is exactly completely hidden behind the metal 107 in the patterned metal layer of the array substrate 101, and the sealant 104 is exactly completely exposed in the gap 108 in the patterned metal layer of the array substrate 101.

Of course, in other embodiments, some changes can be made to the arrangements of the spacer 105 and the sealant 104. The arrangements of the spacer 105 and the sealant 104 may not be completely consistent with the patterned metal layer. It is only necessary that a position of at least part of the sealant 104 corresponds to the gap 108 in the patterned metal layer of the array substrate 101, and a position of at least part of the spacer 105 corresponds to the metal 107 in the patterned the metal layer of the array substrate 101, so as to achieve the objective of the present disclosure.

FIG. 4 schematically shows a transmission of ultraviolet light through the liquid crystal display panel 100 shown in FIG. 1. In the process of curing the sealant 104, ultraviolet light will irradiate the liquid crystal display panel 100 (which is a semi-finished product) from the side of the array substrate 101. As shown in FIG. 4, ultraviolet light 109 cannot penetrate the metal 107 in the patterned metal layer when passing through the array substrate 101, but it can penetrate the gap 108 in the patterned metal layer and continue projecting. In this case, the sealant 104 at the position corresponding to the gap 108 can receive sufficient radiation of the ultraviolet light 109, thereby being cured completely. Since the spacer 105 does not need to be irradiated by ultraviolet light, there would be no negative influence on a process technology of the entire liquid crystal display panel. What's most important is that the sealant 104 according to the embodiment shown in FIG. 4 can be sufficiently irradiated and completed cured, which the prior art cannot achieve.

In an embodiment as shown by FIG. 4, in the process of curing the sealant 104 with the ultraviolet light 109, the sealant 104 is completely exposed to the ultraviolet light 109 passing through the gap 108 in the patterned metal layer of the array substrate 101. As a result, energy of the ultraviolet light 109 can be made use of to the largest extent, and the sealant 104 can have the strongest adhesive force. Besides, because the arrangements according to the present disclosure has made the best of the smallest possible space occupied by the frame, it is unnecessary to fear for not being able to realize the design of narrow frame.

In order to receive the design of narrow frame, a sum total of a width d1 of the color filter and a width d2 of the sealant should be kept within a certain range. However, if the width d1 of the color filter is too big, the width d2 of the sealant would be too small, such that an adhesion of the sealant will be insufficient, whereby an upper substrate and a lower substrate would be separated with only slight external force. If the width d1 of the color filter is too small, the width d2 of the sealant would be too big, whereby gap mura would occur due to lack of support force between the upper and the lower substrates. Therefore, the width d1 of the color filter and the width d2 of the sealant should satisfy a strict limitation. According to the manners of arranging the sealant 104 and the spacer 105 respectively shown by FIG. 2 and FIG. 4, a total width of the sealant 104 and the spacer 105 can satisfy strict requirement, whereby sufficient support force can be ensured, a cured area of the sealant can be increased, adhesive force of the sealant can be effectively improved, and requirements for realizing the design of narrow frame can be met.

FIG. 5 shows a broken-out section view of a liquid crystal display panel 300 according to another embodiment of the present disclosure. The liquid crystal display panel 300 comprises an array substrate 301, a color filter substrate 302, and a sealant 304 disposed between the array substrate 301 and the color filter substrate 302. A patterned metal layer is disposed on the side of the array substrate 301 that is facing the color filter substrate 302. The patterned metal layer comprises metal 307 and gap 308. An insulating layer 306 is disposed covering the patterned metal layer. The sealant 304 corresponds to the gap 308 in the patterned metal layer of the array substrate 301, and spacer 305 and spacer 305.1 correspond to the metal 307 in the patterned metal layer of the array substrate 301.

In another embodiment as shown by FIG. 5, the spacers in the liquid crystal display panel 300 are also composed of color filter on the color filter substrate 302. As shown in FIG. 5, the spacers are composed of two layers of color filter (305, 305.1) stacked on each other. The spacers formed by two stacked layers of color filter will not increase manufacturing procedure of the existing liquid crystal display panel. For example, the spacers can be composed of stacked red color filter layer 305 and blue color filter layer 305.1.

Alternatively, the spacers can be composed of stacked red color filter layer and green color filter layer. Alternatively, the spacers can be composed of stacked blue color filter layer and green color filter layer.

For some liquid crystal display panels, a single layer of color filter may not be high enough to support a pre-determined liquid crystal cell gap. In this case, in an embodiment as shown by FIG. 5, double layer color filter (305, 305.1) (which can be a combination of color filter of two colors selected from the three primary colors of red, green, and blue) is used. Of course, the color filter thus configured is not definitive. Based on manufacturing procedures of different liquid crystal display panels, the spacer can be composed of single layer color filter, of triple layer color filter, or of four-layer color filter (directing at a RGBW panel), depending upon the existing manufacturing procedure of the filtering color filter, or through extra procedure.

A comparison example is designed to illustrate the advantages of the liquid crystal display panel according to the present disclosure.

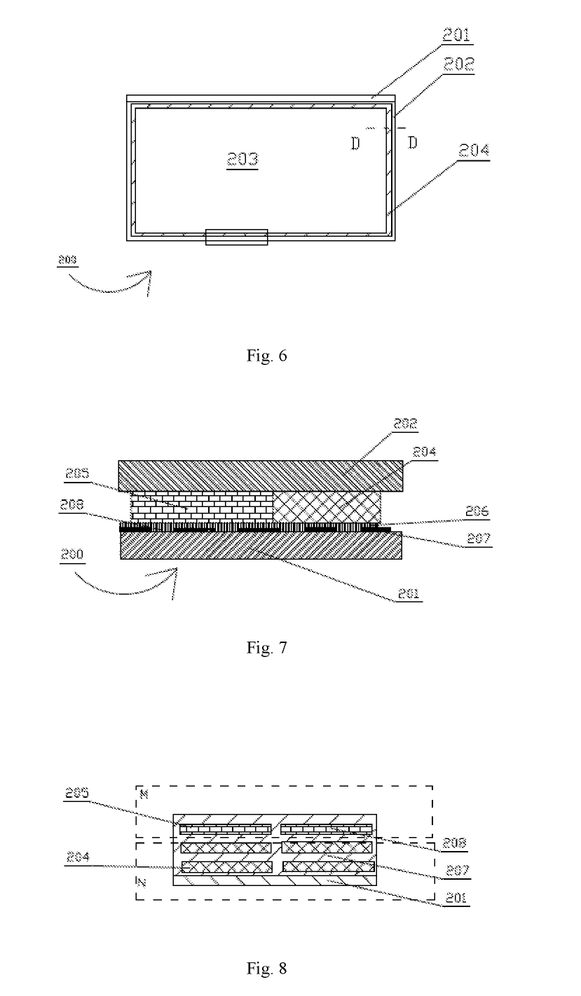

FIG. 6 shows a liquid crystal display panel 200 according to the comparison example.

As shown in FIG. 6, the liquid crystal display panel 200 according to the comparison example comprises an array substrate 201, a color filter substrate 202, and a sealant 204 disposed between the array substrate 201 and the color filer substrate 202. A patterned metal layer is disposed on the side of the array substrate 201 that is facing the color filter substrate 202. The patterned metal layer comprises metal 207 and a gap 208 (as shown in FIG. 7) disposed between the metal. An insulating layer 206 (as shown in FIG. 7) is disposed covering the patterned metal layer.

In an active area 203 of the liquid crystal display panel 200, a liquid crystal interlayer is disposed between the array substrate 201 and the color filter substrate 202. As clearly shown in FIG. 6, the sealant 204 is disposed at edges around the liquid crystal display panel 200 for encapsulating the liquid crystal interlayer.

FIG. 7 shows a section view along a line D-D of the liquid crystal display panel 200 shown in FIG. 6.

As clearly shown in FIG. 7, the sealant 204 is concentrated on the side that is away from the liquid crystal interlayer. In another aspect, the liquid crystal display panel 200 further comprises spacer 205 disposed between the array substrate 201 and the color filter substrate 202. The spacer 205 is concentrated on the side that is adjacent to the liquid crystal interlayer. The spacer 205 can be composed of color filter on the color filter substrate 202.

FIG. 8 shows a vertical section view of the liquid crystal display panel 200 shown in FIG. 6 in a rectangle frame (i.e., observed from one side of an array substrate). In view of FIG. 8, it should be easy to understand that if the liquid crystal display panel 200 is observed from the side of the array substrate 201, a part of the spacer 205 will be hidden behind the metal 207 in the patterned metal layer of the array substrate 201, and the rest of the spacer 205 will be exposed in the gap 208 in the patterned metal layer of the array substrate 201, as shown by an area enclosed by a dashed line M in FIG. 8. It is the same with the sealant 204. If the liquid crystal display panel 200 is observed from the side of the array substrate 201, a part of the sealant 204 will be hidden behind the metal 207 in the patterned metal layer of the array substrate 201, and the rest of the sealant 204 will be exposed in the gap 208 in the patterned metal layer of the array substrate 201, as shown by an area enclosed by a dashed line N in FIG. 8

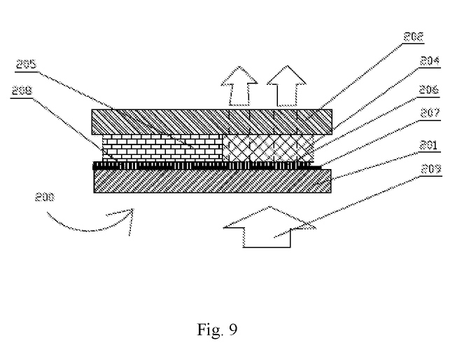

FIG. 9 schematically shows a transmission of ultraviolet light through the liquid crystal display panel 200 according to the comparison example shown in FIG. 6. In the step of curing the sealant 204, ultraviolet light 209 irradiates the liquid crystal display panel 200 (which is a semi-finished product) from the side of the array substrate 201. As shown in FIG. 9, the ultraviolet light 209 cannot penetrate the metal 207 in the patterned metal layer when passing through the array substrate 201, but it can penetrate the gap 208 in the patterned metal layer and continue projecting. In this case, the sealant 204 at a position corresponding to the gap 208 can receive sufficient radiation of the ultraviolet light 209, thereby being cured. However, the sealant 204 at a position corresponding to the metal 207 will not receive radiation of the ultraviolet light 209. There is a risk that this part of the sealant 204 will not be cured, which brings potential peril to the quality of the entire liquid crystal display panel.

It should be easy to understand the advantages of the liquid crystal display panel according to the present disclosure through comparing FIG. 4 with FIG. 9. In the liquid crystal display panel according to the present disclosure, the color filter and the sealant are segmented and arranged based on the characteristics of curing of the frame, so that the shape of the color filter, which acts as spacer, can be consistent with the shape of the metal in the patterned metal layer, and the sealant is filled in the gap in the patterned metal layer. In this case, the color filter, which acts as the spacer, is composed covering the metal in the patterned metal layer. The color filter itself does not need to be irradiated by ultraviolet light. On the other hand, the sealant in the gap between the metal in the patterned metal layer can be irradiated by ultraviolet light, whereby a cured area of the sealant by ultraviolet light can be increased. In this manner, the curing of the sealant of the liquid crystal display panel with an especially narrow frame can be facilitated, the adhesive force between the upper and the lower substrates of the liquid crystal display panel can be increased, and the support force therebetween can be guaranteed through the spacer.

The present disclosure has been described with reference to preferred embodiments, which are only examples for illustrating the principle and application of the present disclosure. It should be understood that various modifications and variants to the present disclosure may be made by anyone skilled in the art, without departing from the scope and spirit of the present disclosure. In particular, various dependent claims and technical features described herein may be combined with one another in any different manner from the original claims. It should also be understood that the technical features described in view of a single example can also be applied to other examples.

1. A liquid crystal display panel, comprising:
an array substrate,
a color filter substrate, and
a sealant disposed between the array substrate and the color filter substrate,
wherein, a position of at least part of the sealant corresponds to a gap in a patterned metal layer of the array substrate.

2. The liquid crystal display panel according to claim 1, further comprising a spacer disposed between the array substrate and the color filter substrate, wherein a position of at least part of the spacer corresponds to a metal in the patterned metal layer of the array substrate.

3. The liquid crystal display panel according to claim 2, wherein the sealant corresponds to the gap, and the spacer corresponds to the metal.

4. The liquid crystal display panel according to claim 2, wherein the spacer is composed of color filter on the color filter substrate.

5. The liquid crystal display panel according to claim 4, wherein the spacer is composed of at least two stacked layers of color filter.

6. The liquid crystal display panel according to claim 5, wherein the spacer is composed of stacked red color filter layer and blue color filter layer, and/or stacked red color filter layer and green color filter layer, and/or stacked blue color filter layer and green color filter layer.

7. The liquid crystal display panel according to claim 2, wherein cross sections of both the sealant and the spacer are trapezoid; the sealant and the spacer are staggered with each other, and the sealant is fit to an adjacent spacer in a gapless manner.

8. The liquid crystal display panel according to claim 1, wherein in a process of curing the sealant with ultraviolet light, the sealant is completely exposed to the ultraviolet light passing through the array substrate by the gap in the patterned metal layer.

9. The liquid crystal display panel according to claim 4, wherein the spacer is composed of the color filter, and the spacer and the color filter on the color filter substrate are formed in a same process.

10. The liquid crystal display panel according to claim 4, wherein the color filter and the sealant each comprise photoresist so as to form a layout manner consistent with the patterned metal layer.
